(19) United States
(12) Patent Application Publication
(10) Pub. No.: US 2016/0140917 A1
(43) Pub. Date: May 19, 2016

(54) CURVED LIQUID CRYSTAL DISPLAY HAVING IMPROVED BLACK MURA CHARACTERISTICS

(71) Applicant: SAMSUNG DISPLAY CO., LTD., Yongin-si (KR)

(72) Inventors: Jun-Woo HYUNG, Seongnam-si (KR); Joo Ae YOUN, Seongnam-si (KR); Dae Young JOUNG, Seongnam-si (KR)

(21) Appl. No.: 14/932,822

(22) Filed: Nov. 4, 2015

(30) Foreign Application Priority Data
Nov. 13, 2014 (KR) 10-2014-0158330

(51) Int. Cl. G09G 3/36; G09G 3/34

(52) U.S. Cl. CPC G09G 3/3607; G09G 3/3696; G09G 3/3426; G09G 3/3413; G09G 2320/0238

(57) ABSTRACT

A curved liquid crystal display (LCD) includes: a curved liquid crystal panel assembly; a look-up table storing correction values, the correction values being values for selectively correcting image signals for a black mura region where black mura generated in the curved liquid crystal panel assembly; and a signal controller for generating an image data signal adjusted by the correction values of the image signals for the black mura region.

### CROSS-REFERENCE TO RELATED APPLICATION

This application claims priority to, and the benefit of, Korean Patent Application No. 10-2014-0158330 filed in the Korean Intellectual Property Office on Nov. 13, 2014, the entire contents of which are incorporated herein by reference.

### BACKGROUND

(a) Field

Embodiments of the present invention relate generally to liquid crystal displays. More specifically, embodiments of the present invention relate to curved liquid crystal displays (LCDs) and accompanying driving methods for removing black mura.

(b) Description of the Related Art

As one of the most widely used flat panel displays at present, a liquid crystal display (LCD) includes two display panels on which field generating electrodes such as a pixel electrode and a common electrode are formed, and a liquid crystal layer interposed between the two display panels. The LCD displays an image by applying a voltage to the field generating electrodes, thus generating an electric field in the liquid crystal layer. The electric field determines alignment directions of liquid crystal molecules of the liquid crystal layer, thereby controlling polarization of incident light.

Recently, demand has been expressed for LCDs that are larger and that are also curved, so as to enhance immersion and realism of viewers.

Currently, curved LCDs are manufactured to have a constant curvature, by applying a bending force to a flat LCD. However, when this bending force is applied, shear stress generated in the LCD causes a change in phase retardation of a glass substrate, thereby generating what is known as black mura, or a “smudge” in which a specific region is displayed brighter than surrounding areas because of light leakage when the curved LCD displays a black screen. Such black mura deteriorates display quality of the curved LCD.

The above information disclosed in this Background section is only for enhancement of understanding of the background of the invention and therefore it may contain information that does not form the prior art that is already known in this country to a person of ordinary skill in the art.

### SUMMARY

Embodiments of the present invention provide a curved liquid crystal display (LCD) for removing black mura that can occur in the curved LCD, and a driving method therefor.

The curved LCD according to an exemplary embodiment of the present invention includes: a curved liquid crystal panel assembly; a look-up table storing correction values, the correction values being values for selectively correcting image signals for a black mura region of the curved liquid crystal panel assembly; and a signal controller for generating an image data signal adjusted by the correction values of the image signals for the black mura region.

When a black image is displayed, the signal controller may be programmed to generate the image data signal so as to generate a predetermined electric field in portions of the curved liquid crystal panel assembly corresponding to the black mura region, and to generate no electric field in normal regions corresponding to portions of the curved liquid crystal panel assembly outside the black mura region.

When the black image is displayed, a voltage of the image data signal applied to the black mura region and a voltage of the image data signal applied to the normal regions may be different from each other.

When a white image is displayed on the curved liquid crystal panel assembly, a voltage of the image data signal applied to the black mura region and a voltage of the data signal applied to the normal regions may be different from each other.

When a white image is displayed on the curved liquid crystal panel assembly, a voltage of the image data signal applied to the black mura region and a voltage of the image data signal applied to the normal regions may be substantially identical.

When an arbitrary gray level image is displayed on the curved liquid crystal panel assembly, a voltage of the image data signal applied to the black mura region and a voltage of the image data signal applied to the normal regions may be different from each other.

A method of driving a curved LCD including a curved liquid crystal panel assembly according to another exemplary embodiment of the present invention includes: receiving an image signal for displaying an image; retrieving correction values, the correction values being correction values for image signals for an image to be displayed in a black mura region of a curved liquid crystal panel assembly; generating an image data signal by correcting the image signals based on the retrieved correction values; and displaying the image on the liquid crystal panel assembly according to the image data signal.

The generating an image data signal may further comprise, while a black image is displayed on the curved liquid crystal panel assembly, generating a predetermined electric field in portions of the curved liquid crystal panel assembly corresponding to the black mura region, and generating no electric field in normal regions corresponding to portions of the curved liquid crystal panel assembly outside the black mura region.

The generating an image data signal may further comprise, while a black image is displayed on the curved liquid crystal panel assembly, applying a first data signal voltage to the black mura region of the curved liquid crystal panel assembly and applying a second data signal voltage to the normal region of the curved liquid crystal panel assembly, the first and second data signal voltages being different from each other.

A curved LCD according to a further exemplary embodiment of the present invention includes: a curved liquid crystal panel assembly; a detection panel disposed on the curved liquid crystal panel assembly to detect light passing through the liquid crystal panel assembly; a black mura detection unit detecting a black mura region corresponding to black mura generated in the curved liquid crystal panel assembly; and a signal controller for generating an image data signal selectively adjusted according to location information of the black mura region.

When a black image is displayed, the signal controller may be further programmed to generate the image data signal so as to generate a predetermined electric field in portions of the curved liquid crystal panel assembly corresponding to the black mura region, and to generate no electric field in normal regions corresponding to portions of the curved liquid crystal panel assembly outside the black mura region.

The detection panel may include: a plurality of detection gate lines; a plurality of detection lines; and a plurality of detection pixels connected to the plurality of detection gate lines and the plurality of detection lines to measure an amount of light passing through the curved liquid crystal panel assembly.

The black mura detection unit may be connected to the plurality of detection gate lines and the plurality of detection lines, may be programmed to sequentially apply a gate-on voltage to the plurality of detection gate lines, and may be further programmed to receive light detection signals that are generated in the plurality of detection pixels and transmitted through the plurality of detection lines in response to the gate-on voltage.

The black mura detection unit may be programmed to detect a region in which the light detection signals exceed a predetermined reference value, so as to detect the black mura region.

The reference value may be a voltage corresponding to an amount of current that can be generated in one detection pixel by external light.

The black mura detection unit may be further programmed to calculate the reference value according to an average value of the light detection signals of the plurality of detection pixels.

A method of driving a curved LCD according to a further exemplary embodiment of the present invention includes: sequentially transmitting a gate-on voltage to a plurality of detection gate lines while a black image is displayed; receiving light detection signals generated by a plurality of detection pixels connected to the plurality of detection gate lines; determining whether the light detection signals exceed a reference value; determining a black mura region according to positions of those detection pixels having voltages of the light detection signals that exceed the reference value; generating black mura region information indicating a position of the black mura region; and correcting an image data signal corresponding to the black mura region based on the black mura region information.

When a black image is displayed on a curved liquid crystal panel assembly, a voltage of the data signal applied to display pixels corresponding to the black mura region and a voltage of the data signal applied to display pixels corresponding to locations outside the black mura region may be different from each other.

A curved LCD according to a further exemplary embodiment of the present invention includes: a lower panel including a first polarizer and a first insulation substrate; an upper panel including a second polarizer and a second insulation substrate; a liquid crystal layer interposed between the lower and upper panels; and a phase compensation layer disposed on one of the lower panel and the upper panel. The phase compensation layer may have different phase delay values for a black mura region of the curved upper and lower panels and a normal region outside the black mura region.

The phase compensation layer may be disposed between the first polarizer and the second polarizer.

The black mura that can occur in the curved LCD may thereby be removed.

### BRIEF DESCRIPTION OF THE DRAWINGS

FIG. 1 is a block diagram of a curved liquid crystal display (LCD) according to an exemplary embodiment of the present invention.

FIG. 2 is a circuit diagram of one pixel of the curved LCD according to an exemplary embodiment of the present invention.

FIG. 3 is a top plan view of one pixel of the curved LCD according to an exemplary embodiment of the present invention.

FIG. 4 is a cross-sectional view of FIG. 3 taken along the line IV-IV.

FIG. 5 is a drawing schematically illustrating a curved liquid crystal panel assembly in the curved LCD according to an exemplary embodiment of the present invention.

FIG. 6 is a drawing illustrating a simulation result of shear stress applied to the curved liquid crystal panel assembly in the curved LCD according to an exemplary embodiment of the present invention.

FIG. 7 is a top plan view illustrating polarization variations in a normal region where no black mura occurs.

FIG. 8 is a top plan view illustrating polarization variations in a black mura region where black mura occurs.

FIG. 9 is a flowchart illustrating a driving method for the curved LCD according to an exemplary embodiment of the present invention.

FIG. 10 is a graph illustrating one exemplary relationship between data signal voltages and gray levels for the normal region and the black mura region of the curved LCD according to an exemplary embodiment of the present invention.

FIG. 11 is a graph illustrating another exemplary relationship between data signal voltages and gray levels for the normal region and the black mura region of the curved LCD according to an exemplary embodiment of the present invention.

FIG. 12 is a top plan view illustrating polarization variations in the black mura region when operating the curved LCD according to an exemplary embodiment of the present invention.

FIG. 13 is a block diagram of a curved LCD according to another exemplary embodiment of the present invention.

FIG. 14 is a block diagram of a black mura detection device for detecting black mura of the curved LCD according to another exemplary embodiment of the present invention.

FIG. 15 is a circuit diagram of one detection pixel included in the black mura detection device of FIG. 14.

FIG. 16 is a flowchart illustrating a driving method for the curved LCD according to another exemplary embodiment of the present invention.

FIG. 17 is a cross-sectional view of one pixel of a curved LCD according to a further exemplary embodiment of the present invention.

FIG. 18 is a perspective view of a phase compensation layer PS included in the curved LCD of FIG. 17.

FIG. 19 is a top plan view illustrating polarization variations in the curved LCD of FIG. 17.

FIG. 20 is a cross-sectional view of one pixel of a curved LCD according to a further exemplary embodiment of the present invention.

FIG. 21 is a top plan view illustrating polarization variations in the curved LCD of FIG. 20.

### DETAILED DESCRIPTION OF THE EMBODIMENTS

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention. Further, in exemplary embodiments, since like reference numerals designate like elements having the same configuration, a first exemplary embodiment is representatively described, and in other exemplary embodiments, only different configurations from the first exemplary embodiment will be described.

Parts that are irrelevant to the description will be omitted to clearly describe the present invention, and the same or similar constituent elements will be designated by the same reference numerals throughout the specification.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising” will be understood to imply the inclusion of stated elements but not the exclusion of any other elements.

In the drawings, the thickness of layers, films, panels, regions, etc., are exaggerated for clarity. Accordingly, the various Figures are not to scale. Like reference numerals designate like elements throughout the specification.

It will be understood that when an element such as a layer, film, region, or substrate is referred to as being “on” another element, it can be directly on the other element or intervening elements may also be present. In contrast, when an element is referred to as being “directly on” another element, there are no intervening elements present.

A curved liquid crystal display (LCD) according to an exemplary embodiment of the present invention will now be described in detail with reference to the drawings.

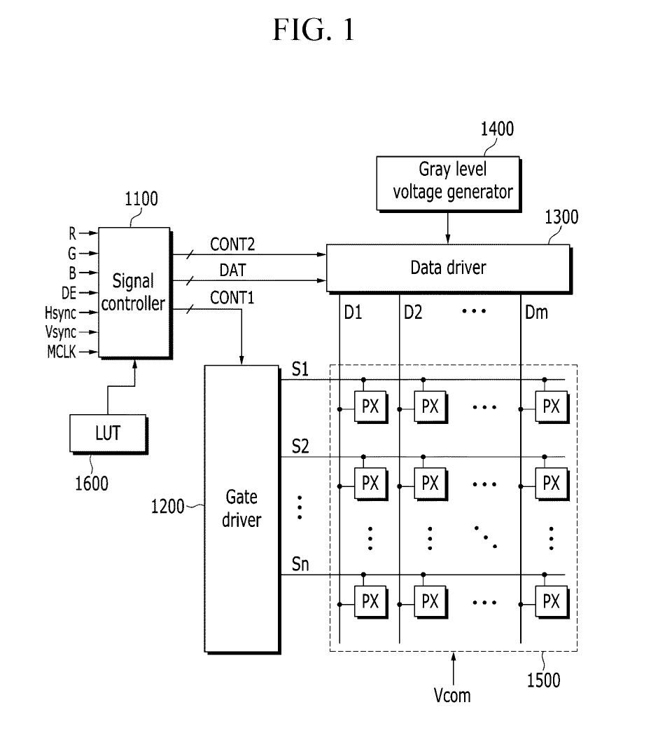

FIG. 1 is a block diagram of the curved LCD according to the exemplary embodiment of the present invention. Referring to FIG. 1, the curved LCD includes a signal controller 1100, a gate driver 1200, a data driver 1300, a gray-level voltage generator 1400, a liquid crystal panel assembly 1500, and a look-up table (hereinafter referred to as LUT) 1600.

The liquid crystal panel assembly 1500 includes a plurality of gate lines S1 to Sn, a plurality of data lines D1 to Dm, and a plurality of pixels PX. The pixels PX are arranged in an approximate matrix form while being connected to the plurality of gate lines S1 to Sn and the plurality of data lines D1 to Dm.

The plurality of gate lines S1 to Sn substantially extend in a row direction such that they are nearly parallel to each other. The plurality of data lines D1 to Dm substantially extend in a column direction such that they are nearly parallel to each other. Herein, only the plurality of gate and data lines S1 to Sn and D1 to Dm are illustrated to be connected to the plurality of pixels PX, but various other signal lines such as a power supply line, a divided reference voltage line, and the like may be additionally connected to the plurality of pixels PX depending on structures of the pixels PX, a driving method, and the like.

Meanwhile, backlights (not shown) may be provided at a rear side of the liquid crystal panel assembly 1500 to provide light for an image that is displayed on the liquid crystal panel assembly 1500. More specifically, the backlights emit light toward the liquid crystal panel assembly 1500.

The signal controller 1100 receives image signals R, G, and B and an input control signal. The image signals R, G, and B contain luminance information for the plurality of pixels. Luminance has a predetermined number of gray levels, for example, 1024=2¹⁰, 256=2⁸ or 64=2⁶.

The input control signal includes a data enable signal DE, a horizontal synchronization signal Hsync, a vertical synchronization signal Vsync, and a main clock signal MCLK.

The signal controller 1100 generates a gate control signal CONT1, a data control signal CONT2, and an image data signal DAT according to the image signals R, G, and B, the data enable signal DE, the horizontal synchronizing signal Hsync, the vertical synchronization signal Vsync, and the main clock signal MCLK. More specifically, the signal controller 1100 identifies the image signals R, G, and B for each frame according to the vertical synchronization signal Vsync and for each gate line according to the horizontal synchronization signal Hsync, thereby generating the image data signal DAT.

The signal controller 1100 may provide the image data signal DAT and the data control signal CONT2 to the data driver 1300.

The data control signal CONT2 is a signal for controlling an operation of the data driver 1300, and includes a horizontal synchronization start signal STH for instructing a transmission start of the image data signal DAT, a load signal LOAD for instructing the data lines D1 to Dm to output a data signal, and a data clock signal HCLK. The data control signal CONT2 may further include a reverse signal RVS for reversing a voltage polarity of the image data signal DAT with respect to a common voltage Vcom.

The signal controller 1100 also provides the gate control signal CONT1 to the gate driver 1200. The gate control signal CONT1 includes at least one clock signal for controlling output of a scanning start signal STV and a gate-on voltage of the gate driver 1200. The gate control signal CONT1 may further include an output enable signal OE for limiting a duration of the gate-on voltage.

The data driver 1300 is connected to the data lines D1 to Dm of the liquid crystal panel assembly 1500, and selects gray-level voltages from the gray-level voltage generator 1400. The data driver 1300 applies the selected gray-level voltages as the data signals to the data lines D1 to Dm.

The gray-level voltage generator 1400 does not provide voltages for all gray levels, but provides only a predetermined number of reference gray-level voltages. In this case, the data driver 1300 may divide the reference gray-level voltages to generate the various levels of gray-level voltages, and may select the data signal from among these various levels.

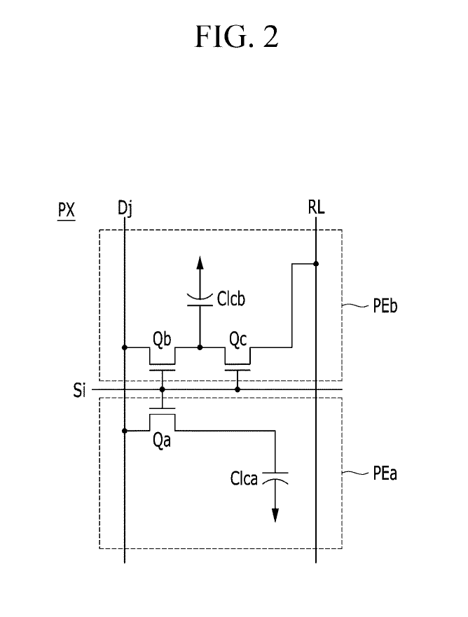

The gate driver 1200 applies a gate signal, which is a combination of the gate-on and gate-off voltages for respectively turning on and turning off the switching elements (Qa, Qb, and Qc of FIG. 2) that are connected to the gate lines S1 to Sn of the liquid crystal panel assembly 1500, to the gate lines S1 to Sn.

Meanwhile, the liquid crystal panel assembly 1500 of this embodiment is a curved-type liquid crystal panel.

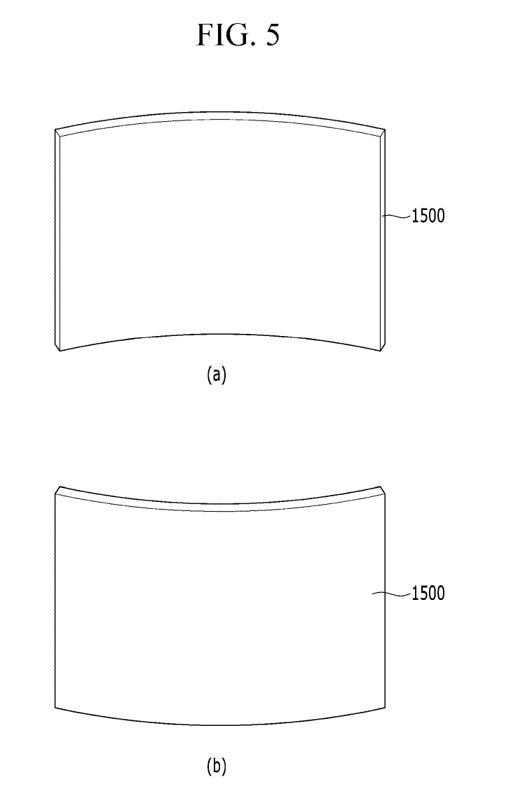

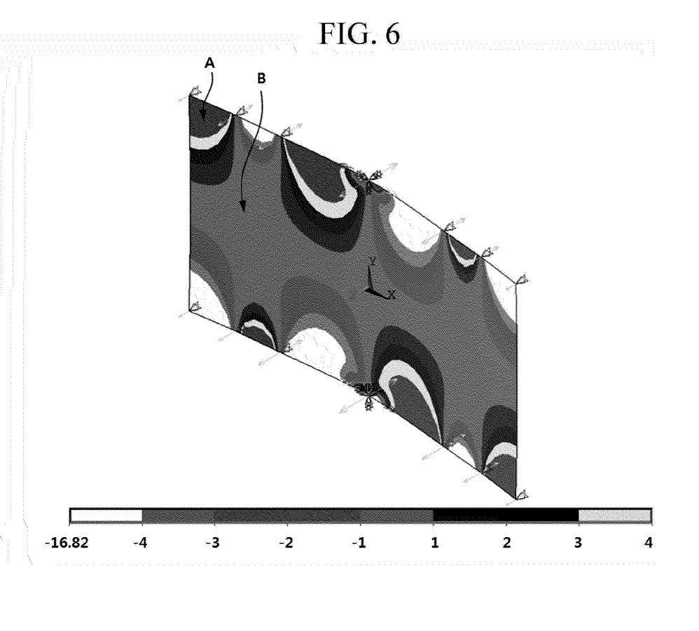

Since the liquid crystal panel assembly 1500 is curved, black mura may occur. The term “black mura” refers to a smudge, or localized visible image defect in which a specific region of an image is displayed brighter than the rest because of light leakage when a black screen is displayed. The black mura may appear on a predetermined specific region depending on shear stress and the like that are applied to the liquid crystal panel assembly 1500. The liquid crystal panel assembly 1500 and its black mura phenomenon will be described below in more detail with reference to FIGS. 5 and 6.

The LUT 1600 stores correction values for the image signals R, G, and B. Particularly, the LUT 1600 stores correction values for image signals R, G, and B for the specific region where the black mura of the liquid crystal panel assembly 1500 appears, that is, a black mura region. In addition, the LUT 1600 may store values of the image signals R, G, and B for a normal region other than the black mura region, i.e. the rest of the display outside of any of its black mura regions. The correction values of the image signals R, G, and B stored in the LUT 1600 are provided to the signal controller 1100. The LUT 1600 may be provided as a non-volatile memory (flash electrically erasable programmable read-only memory) or the like.

The signal controller 1100 may correct the image data signal DAT based on the correction values of the image signals R, G, and B that are received from the LUT 1600.

The image data signal DAT includes the image signals R, G, and B that are identified by each frame and each gate line, and the signal controller 1100 may correct the gray-level values of the image signals R, G, and B corresponding to the black mura region based on the correction values that are received from the LUT 1600.

The image data signal DAT of the black mura region and the image data signal DAT of the normal (non-black mura) region may respectively have different values for the same gray level.

Accordingly, the voltages of the data signals outputted from the data driver 1300 are different from each other for the same gray level in the black mura region and in the normal region outside the black mura region. Particularly, when a black image is displayed, a voltage of the data signal applied to the black mura region and a voltage of the data signal applied to the normal region are different from each other.

Here, a “black image” refers to an image of the lowest gray level, while a “white image” refers to an image of the highest gray level.

When the black image is displayed, the voltage of the data signal applied to the normal region may be a voltage that does not generate an electric field in the liquid crystal panel assembly 1500, while the voltage of the data signal applied to the black mura region may be a voltage that generates a predetermined electric field in the liquid crystal panel assembly 1500.

The LUT 1600 is described such that it is separately provided from the signal controller 1100, but the LUT 1600 may be included in the signal controller 1100.

The signal controller 1100, the gate driver 1200, the data driver 1300, and the gray-level voltage generator 1400 that are described above may be directly mounted on the liquid crystal panel assembly 1500 or on a flexible printed circuit film (not shown) as at least one IC chip, or may be attached to the liquid crystal panel assembly 1500 or mounted on a printed circuit board (PCB) (not shown) as a tape carrier package (TCP). Alternatively, the signal controller 1100, the gate driver 1200, the data driver 1300, and the gray-level voltage generator 1400 may be integrated into the liquid crystal panel assembly 1500 along with the signal lines S1 to Sn and D1 to Dm.

FIG. 2 is a circuit diagram of one pixel of the curved LCD according to an exemplary embodiment of the present invention. A circuit structure of the pixel of the curved LCD according to an exemplary embodiment of the present invention and a driving method thereof will now be described with reference to FIG. 2.

One pixel PX included in the curved LCD includes first to third switching elements Qa, Qb, and Qc, and first and second liquid crystal capacitors Clca and Clcb.

The first and second switching elements Qa and Qb are respectively connected to a gate line Si and a data line Dj. The third switching element Qc is connected to the gate line Si, an output terminal of the second switching element Qb, and a divided reference voltage line RL.

The first and second switching elements Qa and Qb are three-terminal elements such as a thin film transistor or the like, control terminals thereof are connected to the gate line Si, and input terminals thereof are connected to the data line Dj. An output terminal of the first switching element Qa is connected to the first liquid crystal capacitor Clca. An output terminal of the second switching element Qb is connected to the second liquid crystal capacitor Clcb and an input terminal of the third switching element.

The third switching element Qc is also a three-terminal element such as a thin film transistor or the like. A control terminal thereof is connected to the gate line Si, the input terminal thereof is connected to the second liquid crystal capacitor Clcb, and an output terminal thereof is connected to the divided reference voltage line RL.

When a gate-on signal is applied to the gate line Si, the first, second, and third switching elements Qa, Qb, and Qc are turned on. In this case, a data signal is applied to the data line Dj, and the data signal applied to the data line Dj is applied to a first subpixel electrode PEa through the turned-on first switching element Qa and to a second subpixel electrode PEb through the turned-on second switching element Qb.

Since the data signals applied to the first and second subpixel electrodes PEa and PEb are identical to each other, the first and second liquid crystal capacitors Clca and Clcb are charged with the same amount of charge corresponding to a difference between a common voltage and the data voltage, and simultaneously, a voltage charged in the second liquid crystal capacitor Clcb is divided by the turned-on third switching element Qc. Thus, the voltage charged to the second liquid crystal capacitor Clcb is decreased relative to that charged to the first liquid crystal capacitor Clca, by a difference between the common voltage and the divided reference voltage.

Since the voltages of the first and second liquid crystal capacitors Clca and Clcb are different from each other, tilt angles of liquid crystal molecules of first and second subpixels are different, thereby imparting different luminances to the two subpixels. Accordingly, when the voltages of the first and second liquid crystal capacitors Clca and Clcb are appropriately adjusted, an image viewed from the front is close to an image viewed from a side, thereby improving side visibility.

In this case, the circuit of the pixel shown in FIG. 2 is described, but the pixel of the curved LCD according to this exemplary embodiment of the present invention is not limited thereto and thus may be formed to have various structures.

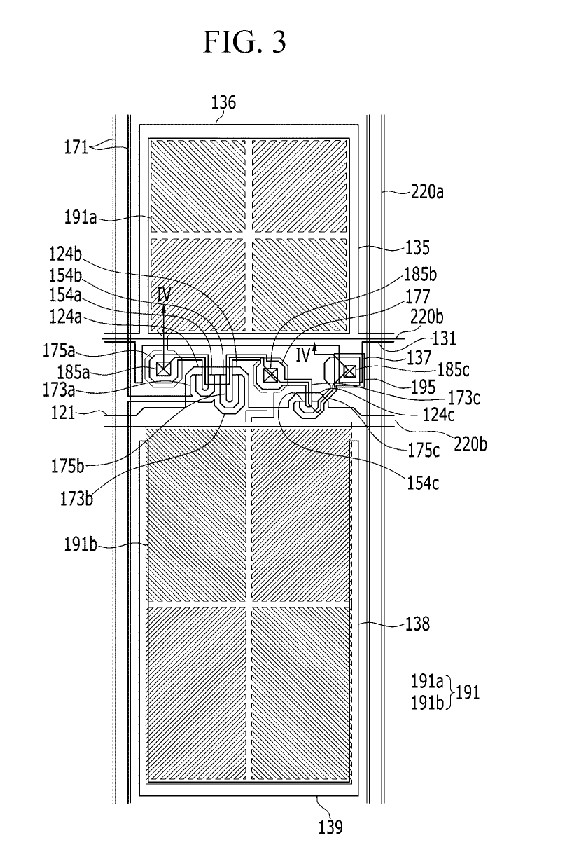

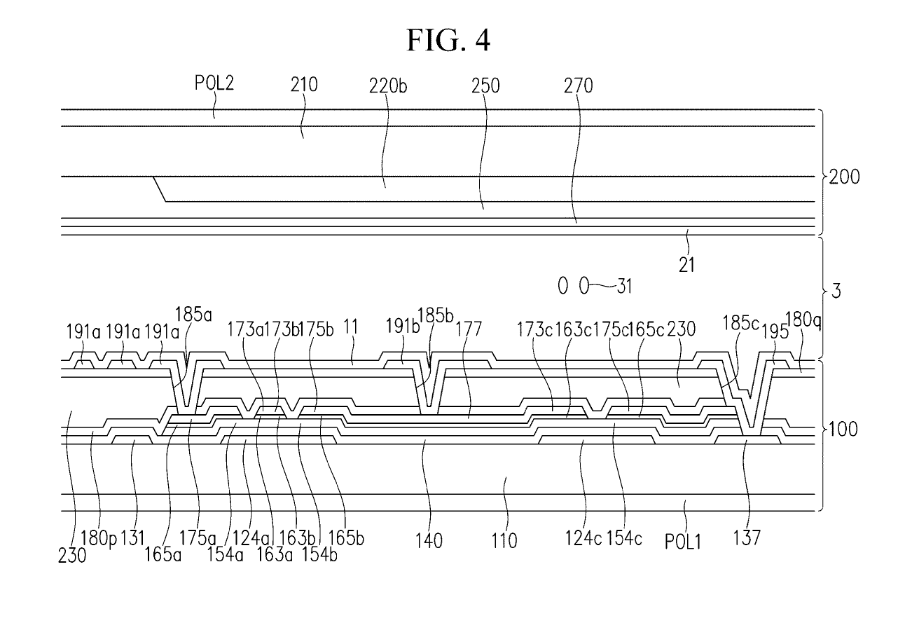

A structure of the liquid crystal panel assembly 1500 of a curved LCD according to the above exemplary embodiment of the present invention will now be described with reference to FIGS. 3 and 4. FIG. 3 is a top plan view of one pixel of the curved LCD according to an exemplary embodiment of the present invention. FIG. 4 is a cross-sectional view of FIG. 3 taken along the line IV-IV.

Referring to FIGS. 3 and 4, the curved LCD includes lower and upper panels 100 and 200 facing each other, and a liquid crystal layer 3 including liquid crystal molecules 31 that are interposed between two display panels 100 and 200. A pair of polarizers POL1 and POL2 is attached to outer surfaces of the two display panels 100 and 200.

The lower panel 100 will be described first. A first polarizer POL1 is disposed under a first insulation substrate 110 that is formed of transparent glass or plastic. A gate conductor, including a gate line 121 and a divided reference voltage line 131, is disposed on the first insulation substrate 110. The gate line 121 includes a first gate electrode 124a, a second gate electrode 124b, a third gate electrode 124c, and a wide end portion (not shown) for connection with another layer or an external driving circuit.

A divided reference voltage line 131 includes first storage electrodes 135 and 136, and a reference electrode 137. Though not connected to the divided reference voltage line 131, second storage electrodes 138 and 139 are also disposed to overlap a second subpixel electrode 191b.

A gate insulating layer 140 is disposed on the gate line 121 and the divided reference voltage line 131, and a first semiconductor layer 154a, a second semiconductor layer 154b, and a third semiconductor layer 154c are disposed on the gate insulating layer 140. A plurality of ohmic contacts 163a, 165a, 163b, 165b, 163c, and 165c are disposed on the semiconductor layers 154a, 154b, and 154c.

A plurality of data lines 171 including first and second source electrodes 173a and 173b, and a data conductor including a first drain electrode 175a, a second drain electrode 175b, a third source electrode 173c, and a third drain electrode 175c are disposed on the ohmic contacts 163a, 165a, 163b, 165b, 163c, and 165c and the gate insulating layer 140. The data conductor, along with the semiconductor and the ohmic contacts disposed thereunder, may be simultaneously formed using one mask.

The data line 171 includes a wide end portion (not shown) for connection to another layer or to an external driving circuit, and may include the semiconductor layers 154a, 154b, and 154c and the ohmic contacts 163a, 165a, 163b, 165b, 163c, and 165c. The semiconductor layers 154a, 154b, and 154c and the ohmic contacts 163a, 165a, 163b, 165b, 163c, and 165c may all have the same shape in plan view (i.e. the view of FIG. 3).

The first gate electrode 124a, the first source electrode 173a, and the first drain electrode 175a collectively form one first thin film transistor Qa along with the first semiconductor layer 154a. A channel of the first thin film transistor Qa is formed in the first semiconductor layer 154a between the first source electrode 173a and the first drain electrode 175a.

Similarly, the second gate electrode 124b, the second source electrode 173b, and the second drain electrode 175b collectively form one second thin film transistor Qb along with the second semiconductor layer 154b. A channel of the second thin film transistor Qb is formed at the second semiconductor layer 154b between the second source electrode 173b and the second drain electrode 175b.

The third gate electrode 124c, the third source electrode 173c, and the third drain electrode 175c together form one third thin film transistor Qc along with the third semiconductor layer 154c. A channel of the third thin film transistor Qc is formed in the third semiconductor layer 154c between the third source electrode 173c and the third drain electrode 175c.

The second drain electrode 175b is connected to the third source electrode 173c and includes a wide expansion 177.

A first passivation layer 180p is disposed on the data conductors 171, 173c, 175a, 175b, and 175c and exposed portions of the semiconductor layers 154a, 154b, and 154c. The first passivation layer 180p may be an inorganic insulating layer that is formed of a silicon nitride or a silicon oxide. The first passivation layer 180p may prevent a pigment of a color filter 230 from flowing into exposed portions of the semiconductor layers 154a, 154b, and 154c.

A vertical light blocking member 220a and the color filter 230 are disposed on the first passivation layer 180p. Either one or both of the vertical light blocking member 220a and the color filter 230 may be disposed on the first passivation layer 180p.

The vertical light blocking member 220a may have a profile that is identical or similar to the data line 171 when viewed in plan view, and is formed to cover the data line 171.

In this case, the light blocking member 220a extending in the vertical direction is described, but the present invention is not limited thereto, and a shielding electrode which is simultaneously formed with the pixel electrode and to which the common voltage is applied may be applied instead of the light blocking member.

The color filter 230 extends in the vertical direction along or between two data lines that are adjacent to each other. Two adjacent color filters 230 may be spaced apart from each other, or may overlap each other in vicinities of the data lines 171.

Each color filter 230 may display one color such as a primary color, and the primary colors may be, for example, three primary colors such as red, green, and blue, or yellow, cyan, magenta, and the like. Though not illustrated, the color filter 230 may further include a color filter for displaying a combination of colors from among the primary colors and/or white.

A second passivation layer 180q is disposed on the vertical light blocking member 220a and the color filter 230. The second passivation layer 180q may be an inorganic insulating layer that is formed of a silicon nitride or a silicon oxide. The second passivation layer 180q prevents the color filter 230 from being lifted and suppresses contamination of the liquid crystal layer 3 by an organic material such as a solvent from the color filter 230, thereby preventing display defects such as a residual image that may appear when a screen is driven.

A first contact hole 185a and a second contact hole 185b are formed in the first passivation layer 180p, the color filter 230, and the second passivation layer 180q to respectively expose the first and second drain electrodes 175a and 175b. A third contact hole 185c is formed in the first passivation layer 180p, the second passivation layer 180q, and the gate insulating layer 140 to partially expose both of the reference electrode 137 and the third drain electrode 175c.

A connecting member 195 covers the third contact hole 185c. The connecting member 195 electrically couples the reference electrode 137 and the third drain electrode 175c that are exposed by the third contact hole 185c.

A plurality of pixel electrodes 191 is disposed on the second passivation layer 180q. The pixel electrodes 191 are separated from each other with the gate lines 121 interposed therebetween, and include a first subpixel electrode 191a and a second subpixel electrode 191b neighboring each other in a column direction on opposite sides of the gate line 121. The pixel electrode 191 may be formed of a transparent conductive material such as ITO, IZO, or the like, or a reflective metal such as aluminum, silver, chromium, or an alloy thereof.

The first subpixel electrode 191a is physically and electrically connected to the first drain electrode 175a through the first contact hole 185a, and receives the data signal from the first drain electrode 175a. The second subpixel electrode 191b is physically and electrically connected to the second drain electrode 175b through the second contact hole 185b, and receives the data signal from the second drain electrode 175b.

The data signal applied to the second drain electrode 175b may be partially divided by the third source electrode 173c, such that a voltage applied to the first subpixel electrode 191a is greater than that applied to the second subpixel electrode 191b.

The first and second subpixel electrodes 191a and 191b to which the data signal is applied generate an electric field along with a common electrode 270 of the upper panel 200 to be described later, thereby determining directions of the liquid crystal molecules of the liquid crystal layer 3 between the two opposing electrodes 191 and 270. Luminance of light passing through the liquid crystal layer 3 varies depending on the determined directions of the liquid crystal molecules, thus modulating light on a per-pixel basis and thereby producing an image.

A lower alignment layer 11 is disposed on the pixel electrode 191.

The upper panel 200 will now be described.

A horizontal light blocking member 220b is disposed on an insulation substrate 210. The horizontal light blocking member 220b is referred to as a black matrix (BM) and prevents leakage of light. The horizontal light blocking member 220b may be disposed to correspond to the gate line 121. That is, the horizontal light blocking member 220b may extend generally in the row direction.

The second polarizer POL2 is disposed over the second insulation substrate 210, that is, on an opposite side of the substrate 210 as the horizontal light blocking member 220b.

An overcoat 250 is formed on the light blocking member 220b. The overcoat 250 may be formed of an organic insulator, and provides a flat surface. In some exemplary embodiments, the overcoat 250 may be omitted.

The common electrode 270 is formed on the overcoat 250. The common electrode 270 may be formed of a transparent conductor such as ITO, IZO, etc.

An upper alignment layer 21 is formed on the common electrode 270.

The liquid crystal layer 3 includes a plurality of liquid crystal molecules 31, and the liquid crystal molecules 31 are aligned such that they are perpendicular to surfaces of the two substrates 110 and 210 when no voltage is applied to the two field generating electrodes 191 and 270. Alternatively, the liquid crystal molecules 31 may be aligned to have pretilts that are tilted in the same direction as a length direction of cutout patterns of the pixel electrode 191.

Black mura generated in the curved liquid crystal panel assembly 1500 of the curved LCD, and a method for removing the black mura, will now be described.

FIG. 5 is a drawing schematically illustrating a curved liquid crystal panel assembly in the curved LCD according to an exemplary embodiment of the present invention.

As shown in FIG. 5, the liquid crystal panel assembly 1500 of the curved LCD may be formed either as a concave type panel or a convex type panel.

From the perspective of the viewer, the concave type panel has a shape with a center portion of the liquid crystal panel assembly 1500 recessed backward from opposing side edges, while the convex type panel has a shape with a center portion of the liquid crystal panel assembly 1500 protruding forward from opposing side edges.

The concave type or the convex type liquid crystal panel assembly 1500 may be formed to have a constant curvature, or may be formed as a multi-curvature type panel such that a curvature of the center portion of the liquid crystal panel assembly 1500 is different from that of the side or edge portions. the constant-curvature liquid crystal panel assembly 1500 is likely to have more severe black mura than the multi-curvature panel assembly. Hereinafter, it is assumed that the liquid crystal panel assembly 1500 is formed as the concave type.

FIG. 6 is a drawing illustrating a simulation result of shear stress applied to a curved liquid crystal panel assembly in a curved LCD according to an exemplary embodiment of the present invention.

Referring to FIG. 6, when the liquid crystal panel assembly 1500 has a constant curvature or a multi-curvature shape due to an external force, a shear stress is generated within. As illustrated in FIG. 6, on a screen of the liquid crystal panel assembly 1500, a region A where the shear stress occurs is distributed in upper and lower edge portions, and a region B where relatively less shear stress occurs is distributed in a center portion. The size and shape of the region A where the shear stress occurs is determined by variables such as a curvature radius of the liquid crystal panel assembly 1500, thicknesses of the first and second insulation substrates 110 and 210, etc. The region A where the shear stress occurs substantially corresponds to the black mura region where the black mura actually occurs. The distribution of the black mura region may also be determined by variables such as the curvature radius of the liquid crystal panel assembly 1500, the thicknesses of the first and second insulation substrates 110 and 210, etc.

If the curvature radius of the liquid crystal panel assembly 1500, the thicknesses of the first and second insulation substrates 110 and 210, etc. are based on a predetermined specification, the distribution of the black mura region may be normalized.

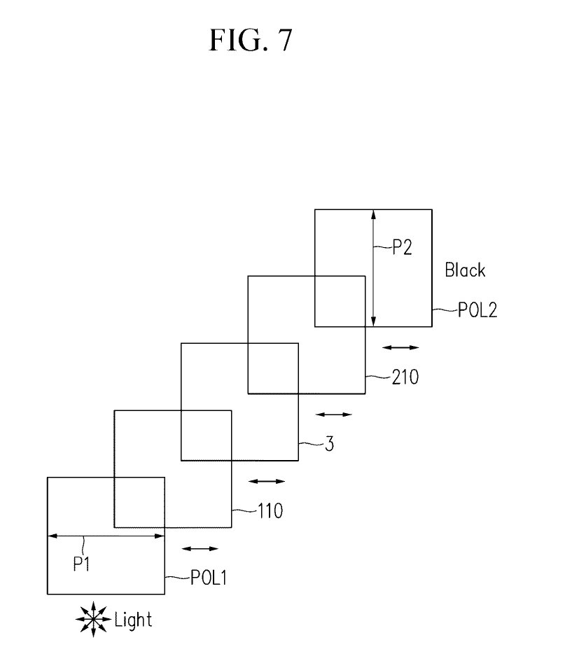

First, referring to FIG. 7, polarization variations in the normal region where no black mura occurs when the LCD displays a black image will now be described. The normal region corresponds to the region B where no shear stress occurs.

FIG. 7 is a top plan view illustrating polarization variations in the normal region where no black mura occurs. Referring to FIG. 7, in the structure of the liquid crystal panel assembly 1500 of the curved LCD described in FIGS. 3 and 4, the first polarizer POL1, the first insulation substrate 110, the liquid crystal layer 3, the second insulation substrate 210, and the second polarizer POL2 contribute to the polarization variations of light emitted from the backlight. For ease of description, only the constituent elements contributing to polarization variations of light will be illustrated, and descriptions of the other constituent elements will be omitted.

The light emitted from the backlight is unpolarized light in which electric fields in all directions are substantially uniformly included.

Polarized light vibrating in one direction along a first polarization axis P1 is transmitted through the first polarizer POL1. Thus, while being transmitted through the first polarizer POL1, the light emitted from the backlight becomes linearly polarized in a direction of the first polarization axis P1.

The normal region corresponds to the region B where no shear stress occurs, and the linearly polarized light is transmitted through the first insulation substrate 110 as linearly polarized light with its polarization unchanged since the first insulation substrate 110, which is a transparent body in the region B where no shear stress occurs, is an isotropic body.

Since the LCD is displaying a black image, the linearly polarized light is transmitted through the liquid crystal layer 3 with its polarization unchanged.

The linearly polarized light is then transmitted through the second insulation substrate 210 as linearly polarized light with its polarization unchanged, since the second insulation substrate 210 is also an isotropic body.

The second polarizer POL2 has a second polarization axis P2 that is perpendicular to the first polarization axis P1 of the first polarizer POL1. The linearly polarized light polarized in the direction of the first polarization axis P1 is thus blocked by the second polarizer POL2. Accordingly, the black image may be displayed.

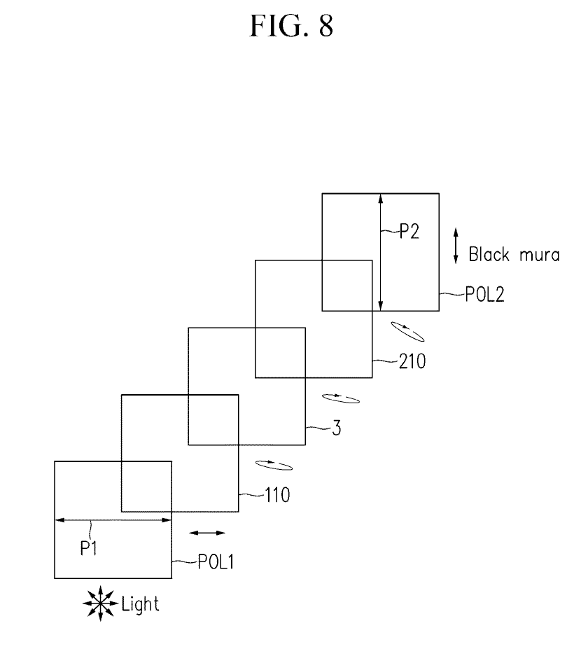

Next, referring to FIG. 8, a situation in which the LCD displays a black image while making no corrections to the image data signal DAT corresponding to the black mura region will be described. The black mura region corresponds to the region A where the shear stress occurs. FIG. 8 is a top plan view illustrating polarization variations in the black mura region where the black mura occurs.

Referring to FIG. 8, the unpolarized light emitted from the backlight becomes linearly polarized light polarized in the first direction of the polarization axis P1 while being transmitted through the first polarizer POL1.

The black mura region corresponds to the region A where the shear stress occurs, and the first insulation substrate 110, which is a transparent body in the region A where the shear stress occurs, is no longer an optically isotropic body due to the shear stress, but instead has birefringence. That is, the first and second insulation substrates 110 and 210 are formed of glass or plastic, which is an isotropic and homogeneous transparent material, and the first and second insulation substrates 110 and 210 do not remain optically isotropic but instead have a birefringence imparted to them when the external force is applied. An example of such a force is that which imparts a curvature to the first and second insulation substrates 110 and 210. A degree of birefringence is proportional to the magnitude of the external force.

The linearly polarized light becomes elliptically polarized light when being transmitted through a birefringent transparent body, that is, the first insulation substrate 110. In elliptically polarized light, an end of a vibration vector of a light wave moves in an elliptical motion. When viewed by a viewer in a travelling direction, the elliptically polarized light may be either one of right elliptically polarized light rotating in a clockwise direction and left elliptically polarized light rotating in a counterclockwise direction. As is known, elliptically polarized light may be a combination of two linearly polarized lights vibrating in directions perpendicular to each other. That is, a linearly polarized light component in the direction of the first polarization axis P1 and a linearly polarized light component in the direction of the second polarization axis P2 are included in the elliptically polarized light.

Since the LCD displays a black image and no electric field is generated in the liquid crystal layer 3, the elliptically polarized light is transmitted through the liquid crystal layer 3 with its polarization unchanged.

As the second insulation substrate 210 also has birefringence, elliptically polarized light passing through the substrate 210 may become elliptically polarized light with the linearly polarized light component in the direction of the second polarization axis P2 further increased.

The linearly polarized light component in the direction of the second polarization axis P2 included in the elliptically polarized light is transmitted through the second polarizer POL2. The linearly polarized light transmitted through the second polarizer POL2 and traveling in the direction of the second polarization axis P2 is visible to a user. Accordingly, the user sees a black mura phenomenon, where a specific area is displayed brighter than its surrounding black area.

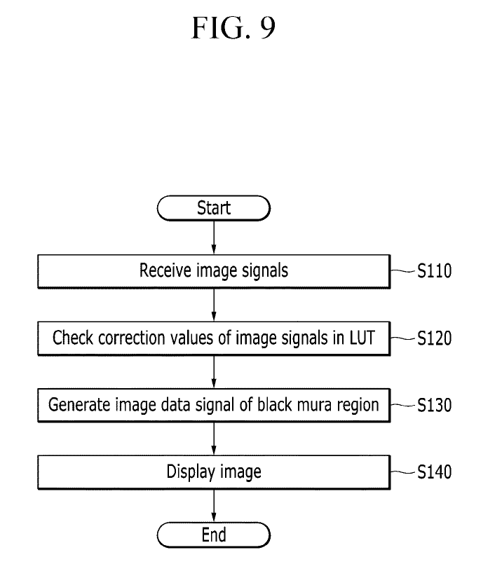

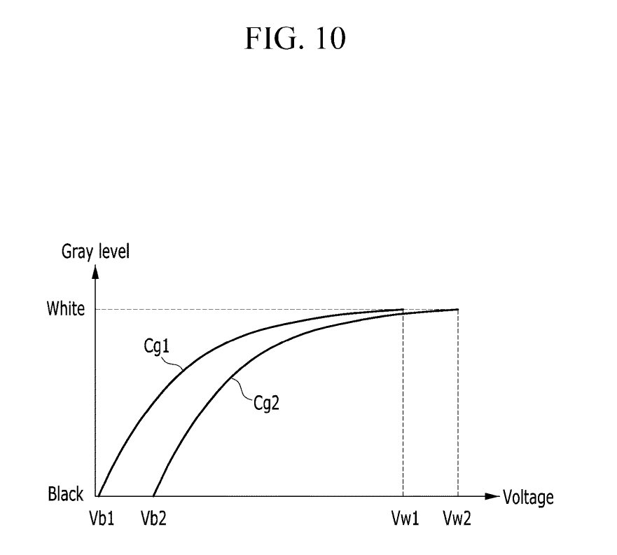

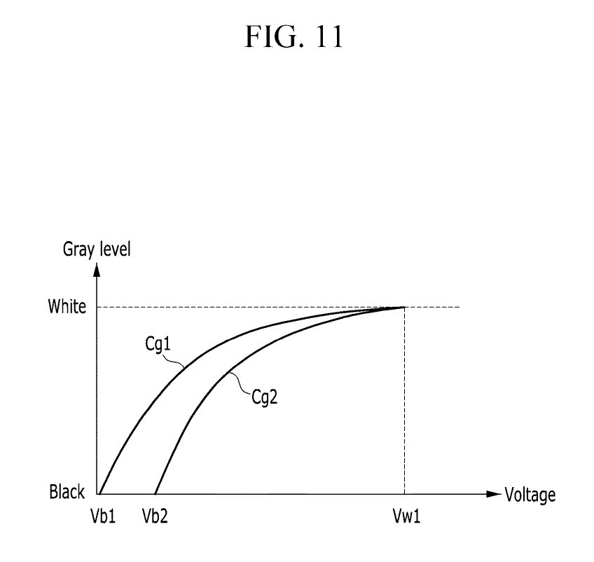

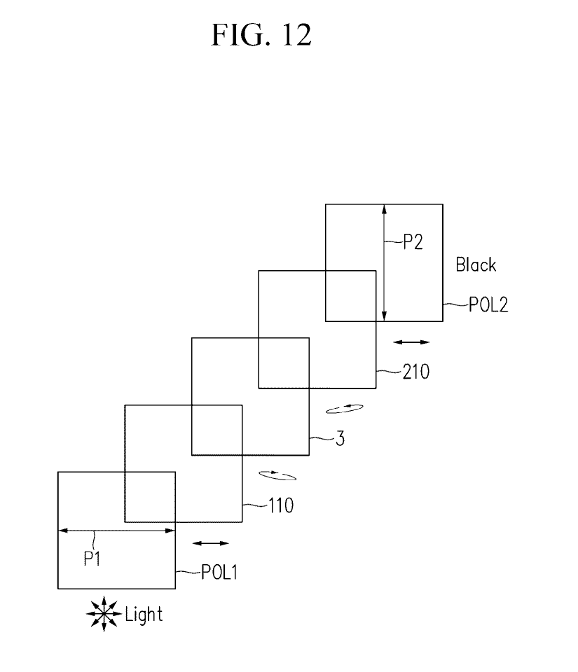

A method of removing black mura in a curved LCD according to an exemplary embodiment of the present invention will now be described with reference to FIGS. 9 to 12. FIG. 9 is a flowchart illustrating a method of driving a curved LCD according to an exemplary embodiment of the present invention. FIG. 10 is a graph illustrating one exemplary relationship between data signal voltages and gray levels for a normal region and a black mura region of a curved LCD according to an exemplary embodiment of the present invention. FIG. 11 is a graph illustrating another exemplary relationship between data signal voltages and gray levels for a normal region and a black mura region of a curved LCD according to an exemplary embodiment of the present invention. FIG. 12 is a top plan view illustrating polarization variations in a black mura region when driving a curved LCD of an exemplary embodiment of the present invention.

Referring to FIGS. 9 to 12, the signal controller 1100 receives image signals R, G, and B (S110). In this case, the signal controller 1100 may know which pixels to apply the image signals R, G, and B to, using an input control signal received along with the image signals R, G, and B.

The signal controller 1100 next checks correction values of the image signals R, G, and B in the LUT 1600 (S120). If a curvature radius of the liquid crystal panel assembly 1500, thicknesses of the first and second insulation substrates 110 and 210, etc., are known (for example, their values can be assumed based on a predetermined specification), the distribution of the black mura region can be predictable. In other words, liquid crystal panel assemblies having same specification make almost identical black mura, and the distribution of the black mura regions can be predictable. For example, black mura may be assumed to occur at any location in which the theoretical stress values rise above a certain threshold value. Accordingly, the LUT 1600 may store correction values for the image signals R, G, and B for the black mura region, where these correction values are determined by the specification of the liquid crystal panel assembly 1500.

The signal controller 1100 generates an image data signal DAT from the image signals R, G, and B by correcting gray-level values of those image signals R, G, and B that correspond to the black mura region. This correction is performed based on the correction values of the image signals R, G, and B that are received from the LUT 1600 (S130).

As the first and second insulation substrates 110 and 210 have birefringence due to shear stress, elliptically polarized light is generated to cause black mura. To compensate for this, the corrected image data signal DAT allows a predetermined electric field to be generated in the black mura region when a black image is displayed. More specifically, the electric field generated in the black mura region reverses the direction of rotation of the elliptically polarized light that is generated by the first and second insulation substrates 110 and 210. That is, when a black image is displayed, a data signal having a specific voltage Vb2 is applied to pixels corresponding to the black mura region. The electric field is generated in the pixels of the black mura region to which the specific voltage Vb2 is applied, and liquid crystal molecules 31 of the black mura region are thereby tilted to change the direction of the elliptically polarized light. For example, when right elliptically polarized light is generated by the first and second insulation substrates 110 and 210, the right elliptically polarized light is changed to left elliptically polarized light by the liquid crystal layer 3 in which the electric field is generated. Conversely, when left elliptically polarized light is generated by the first and second insulation substrates 110 and 210, the left elliptically polarized light is changed to right elliptically polarized light by the liquid crystal layer 3 in which the electric field is generated.

As illustrated in FIG. 10, a relationship between voltages of the data signal and gray levels in the normal region outside a black mura region is represented by curve Cg1. The relationship between the voltages of the data signal and the gray levels in the black mura region may be represented by curve Cg2.

When the voltage of the data signal for a black gray level is Vb1 in the normal region, the voltage of the data signal for the black gray level may be Vb2 in the black mura region such that they are different from each other. In addition, when the voltage of the data signal for a white gray level is Vw1 in the normal region, the voltage of the data signal for the white gray level is Vw2 in the black mura region such that they are different from each other. More generally, for an arbitrary gray level, the voltage of the data signal for the normal region and the voltage of the data signal for the black mura region may be different from each other. As such, when an arbitrary gray level image is displayed on the liquid crystal panel assembly 1500, the voltage of the data signal applied to the black mura region and the voltage of the data signal applied to the normal region are different from each other.

A voltage difference (Vb2−Vb1 or Vw2−Vw1) between the data signal for the black mura region and the data signal for the normal region may be a compensation voltage for compensating the elliptically polarized light that is generated by the first and second insulation substrates 110 and 210. In this case, the image data signal DAT can be compensated by adding a gray-level value corresponding to the compensation voltage to the image signals R, G, and B for the black mura region. The relationship between the voltage of the data signal and the gray level may be stored in the signal controller 1100 or the LUT 1600.

Compared with FIG. 10, FIG. 11 illustrates a case in which the voltage of the data signal for the white gray level in the normal region and the voltage of the data signal for the white gray level in the black mura region are the same value Vw1.

Since visibility of bright images close to the white gray level is not affected much by gray level differences, the voltage of the data signal for the white gray level in the black mura region may be decreased such that it is lower than Vw2. Thus, the white gray level values of both curves Cg1 and Cg2 may be approximated as having the same value. As such, the data signal according to curve Cg1 for the normal region and the data signal according to curve Cg2 for the black mura region are generated based on the corrected image data signal DAT such that they are applied to the plurality of pixels PX of the liquid crystal panel assembly 1500 to remove the black mura effect (S140).

Referring to FIG. 12, after being transmitted through the first polarizer POL1, light linearly polarized in the direction of the first polarization axis P1 becomes right elliptically polarized light rotating in the clockwise direction while passing through the first insulation substrate 110. The right elliptically polarized light becomes left elliptically polarized light rotating in the counterclockwise direction, due to the electric field generated in the pixels of the black mura region within the liquid crystal layer 3.

The left elliptically polarized light then passes through the second insulation substrate 210 such that its linearly polarized light component in the direction of the second polarization axis P2 is compensated while its linearly polarized light component in the direction of the first polarization axis P1 remains.

The light linearly polarized in the direction of the first polarization axis P1 is not allowed to transmit through the second polarizer POL2. Accordingly, the black mura due to the shear stress acting on the first and second insulation substrates 110 and 210 may be removed.

As described above, when the radius of curvature of the liquid crystal panel assembly 1500 has a predetermined nonzero value, the associated black mura may be removed using values stored in the LUT 1600 for the black mura region. However, the curved LCD may alternatively be formed to have a structure in which the radius of curvature of the liquid crystal panel assembly 1500 is arbitrarily controlled by a user. In this case, information about the black mura region for all applicable cases of curvature radius variations of the liquid crystal panel assembly 1500 should be stored in the LUT 1600.

However, there is a limitation in storing the information about the black mura region for all cases, as excessive memory capacity would be required in the LUT 1600.

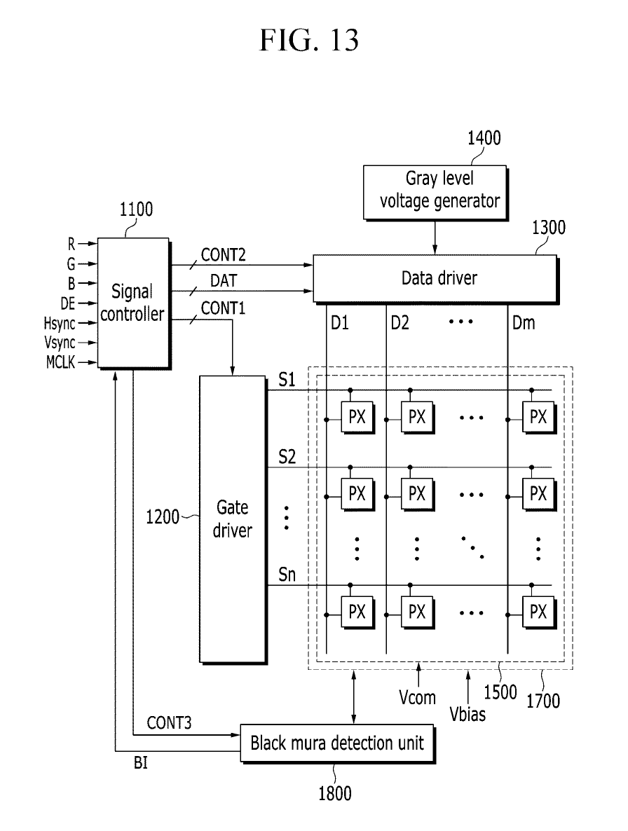

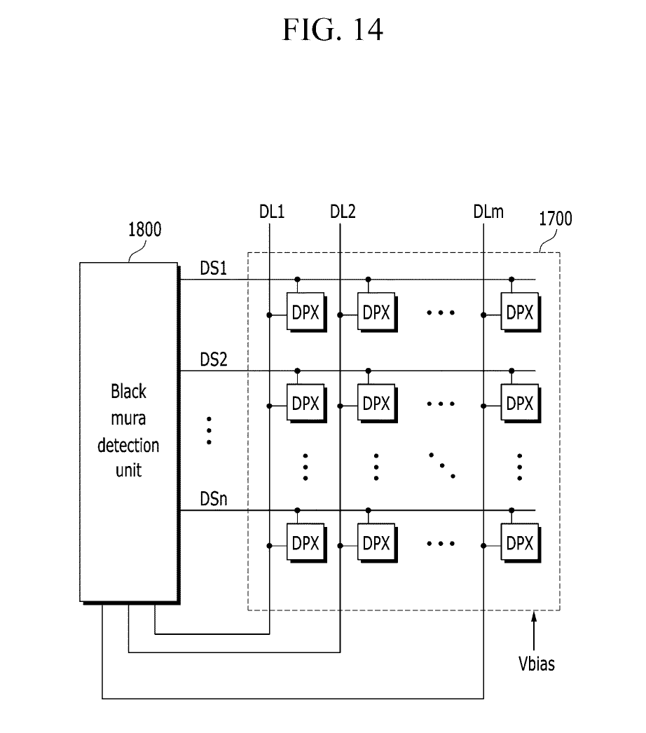

A curved LCD and a method for detecting and removing a black mura region in real time will now be described with reference to FIGS. 13 to 16. FIG. 13 is a block diagram of a curved LCD according to another exemplary embodiment of the present invention. FIG. 14 is a block diagram of a black mura detection device for detecting black mura of a curved LCD according to the exemplary embodiment of FIG. 13.

Compared with FIG. 1, in the curved LCD of FIG. 13 the LUT 1600 is omitted, and included instead is a black mura detection device that has a detection panel 1700 and a black mura detection unit 1800 for detecting the black mura region by driving the detection panel 1700.

The detection panel 1700 is disposed on a liquid crystal panel assembly 1500, and detects light that is emitted from the backlight through the liquid crystal panel assembly 1500. The detection panel 1700 includes a plurality of detection gate lines DS1 to DSn, a plurality of detection lines DL1 to DLm, and a plurality of detection pixels DPX. A bias voltage Vbias for driving the plurality of detection pixels DPX is applied to the detection panel 1700.

The plurality of detection pixels DPX may be arranged in an approximate matrix form while being connected to the plurality of detection gate lines DS1 to DSn and the plurality of detection lines DL1 to DLm. The plurality of detection pixels DPX are provided as elements for measuring an amount of light, and they measure the amount of light passing through the liquid crystal panel assembly 1500. For example, the plurality of detection pixels DPX may be provided as photodiodes for generating a current corresponding to the amount of light. The plurality of detection pixels DPX may be provided at a number corresponding to the plurality of pixels PX. That is, the number and/or spatial positioning of detection pixels DPX may correspond to those of pixels PX. Alternatively, the plurality of detection pixels DPX may be provided at a smaller number than that of the plurality of pixels PX such that, for example, one detection pixel DPX corresponds to two or more pixels PX. Alternatively, the plurality of detection pixels DPX may be provided at a greater number than that of the plurality of pixels PX, such that a plurality of detection pixels DPX correspond to one pixel PX.

The detection gate lines DS1 to DSn substantially extend in a row direction such that they are nearly parallel to each other. The plurality of detection lines DL1 to DLm substantially extend in a column direction such that they are nearly parallel to each other.

A signal controller 1100 provides a detection control signal CONT3 to the black mura detection unit 1800. The detection control signal CONT3 is a signal for controlling the black mura detection unit 1800 to operate in accordance with the time for displaying the image.

The black mura detection unit 1800 is connected to the plurality of detection gate lines DS1 to DSn and the plurality of detection lines DL1 to DLm. The black mura detection unit 1800 may sequentially apply a gate-on voltage to the plurality of detection gate lines DS1 to DSn according to the detection control signal CONT3. Then, the black mura detection unit 1800 receives light detection signals that are generated in the plurality of detection pixels DPX in response to the gate-on voltage and transmitted through the plurality of detection lines DL1 to DLm.

When receiving light detection signals exceeding a predetermined reference value from the detection pixels DPX in regions where a black image is displayed, the black mura detection unit 1800 may determine that these corresponding regions are black mura regions. The black mura detection unit 1800 then transmits information BI about the detected black mura region to the signal controller 1100. The signal controller 1100 may thus remove the black mura by correcting the image data signal DAT corresponding to the black mura region, as above.

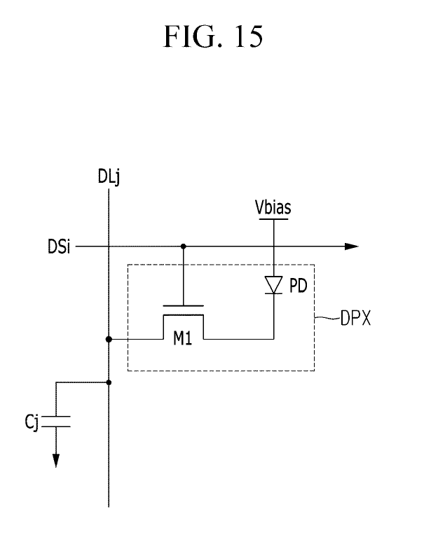

Various kinds of elements for measuring the amount of light may be used as the detection pixels DPX. One exemplary embodiment, in which the photodiodes are used as the detection pixels DPX, will now be described with reference to FIG. 15. FIG. 15 is a circuit diagram of one detection pixel included in the black mura detection device of FIG. 14.

Referring to FIG. 15, each detection pixel DPX includes a switching transistor M1 and a photodiode PD. The switching transistor M1 includes a gate electrode connected to a detection gate line DSi, one electrode connected to a detection line DLj, and the other electrode connected to the photodiode PD. The switching transistor M1 is turned on by a sensing switching signal of the gate-on voltage applied to the detection gate line DSi, and transmits a current generated from the photodiode PD to the detection line DLj.

The photodiode PD includes an anode to which the bias voltage Vbias is provided, and a cathode connected to the other electrode of the switching transistor M1. The photodiode PD generates a current in response to visible light that is incident through, for example, a scintillator layer.

A detection capacitor Cj is connected to the detection line DLj. A plurality of detection capacitors Cj may be provided such that they are respectively connected to the plurality of detection lines DL1 to DLj on a one-to-one basis.

When the black mura detection unit 1800 applies the gate-on voltage to the detection gate line DSi, the switching transistor M1 is turned on. As the switching transistor M1 is turned on, the photodiode PD is connected to the detection line DLj, and the current generated from the photodiode PD flows through the detection line DLj. The detection capacitor Cj is then charged by the current flowing through the detection line DLj. The detection capacitor Cj is charged for a predetermined time during which the switching transistor M1 is turned on, and the detection capacitor Cj is charged to a voltage corresponding to an amount of current that the photodiode PD generates. The voltage charged in the detection capacitor Cj is then transmitted to the black mura detection unit 1800 through the detection line DLj as the light detection signal.

The black mura detection unit 1800 may detect the corresponding detection pixels DPX as the black mura region when the light detection signals transmitted through the detection line DLj exceed a reference value. The reference value may be the voltage corresponding to the amount of current that can be generated in one photodiode PD by external light. The reference value may be changed depending on intensity of the external light. Using an average value of the light detection signals of a plurality of photodiodes PD, the black mura detection unit 1800 may update the reference value as it varies depending on the intensity of the external light.

Meanwhile, the black mura detection unit 1800 may have a ground for resetting the detection capacitor Cj to 0 V, and may reset the detection capacitor Cj whenever receiving the light detection signals for one row of detection pixels DPX.

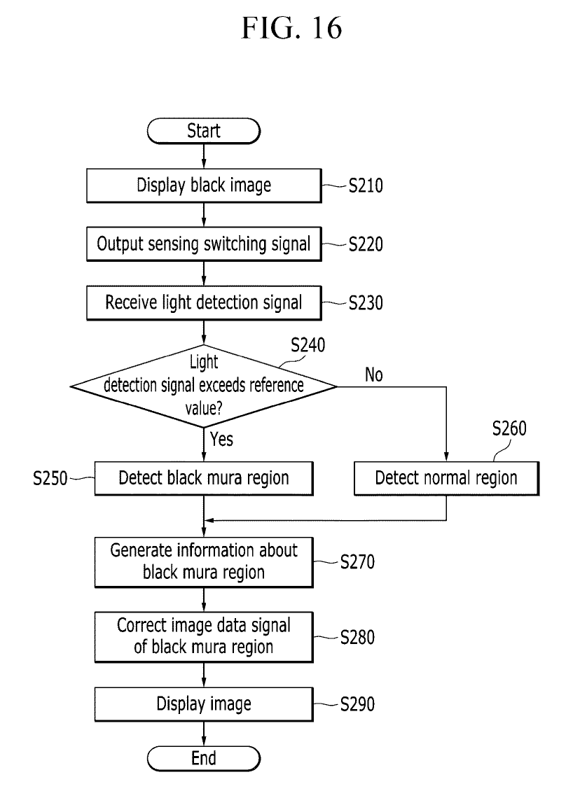

FIG. 16 is a flowchart illustrating a driving method for a curved LCD according to another exemplary embodiment of the present invention. Referring to FIG. 16, a curvature of the liquid crystal panel assembly 1500 may be changed using a device for adjusting the curvature of liquid crystal panel assemblies. Since various disclosed devices are known for use in controlling the curvature of the liquid crystal panel assembly 1500, a detailed description thereof will be omitted.

When the curvature of the liquid crystal panel assembly 1500 is changed, the LCD may display an arbitrary black image (S210). The black image may, for example, be obtained from a previous curvature of the liquid crystal panel assembly 1500, or it may simply set the black data for all of the pixels to the same voltage.

While the black image is displayed, the black mura detection unit 1800 sequentially outputs the sensing switching signal of the gate-on voltage to the plurality of detection gate lines DS1 to DSn (S220). As the sensing switching signal of the gate-on voltage is sequentially outputted thereto, the black mura detection unit 1800 receives the light detection signals generated in the plurality of detection pixels DPX through the plurality of detection lines DL1 to DLm (S230).

The black mura detection unit 1800 then determines whether the light detection signal for each of the plurality of detection pixels DPX exceeds the reference value or not (S240). Since the black image is displayed, there should be no polarized light transmitted through the liquid crystal panel assembly 1500. When black mura occurs, polarized light transmitted through the liquid crystal panel assembly 1500 is generated, and the plurality of detection pixels DPX generate a current corresponding to the polarized light that is transmitted through the liquid crystal panel assembly 1500.

The black mura detection unit 1800 detects positions of the detection pixels DPX where voltages of the light detection signals exceed a reference value, as black mura regions (S250). The black mura detection unit 1800 detects location of the detection pixels DPX where voltages of the light detection signals are below the reference value, as normal regions where no black mura occurs (S260).

The black mura detection unit 1800 generates information BI about the black mura region for indicating a position of the black mura region (S270). Since regions other than the black mura region are designated as normal regions, the information BI about the black mura region may also indicate the positions of the normal regions.

The black mura detection unit 1800 transmits the information BI about the black mura region to the signal controller 1100. The signal controller 1100 then corrects an image data signal DAT corresponding to the black mura region based on the information BI about the black mura region (S280).

As described above, a data signal according to curve Cg1 in the normal region and a data signal according to curve Cg2 in the black mura region are generated to be applied to the plurality of pixels PX, thereby displaying an image removed of black mura (S290). The configuration and method for removing the black mura has been described by correcting the image data signal DAT corresponding to the black mura region, as above.

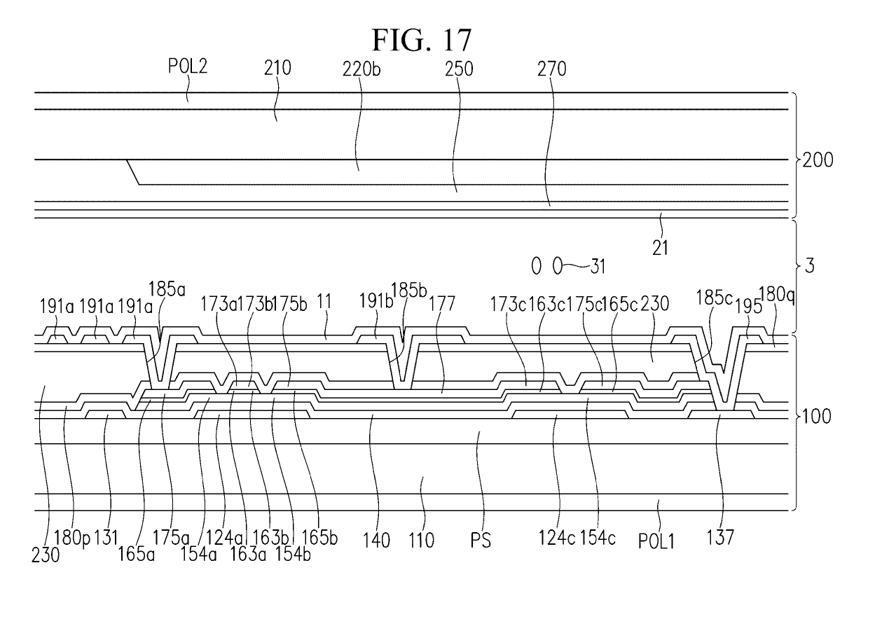

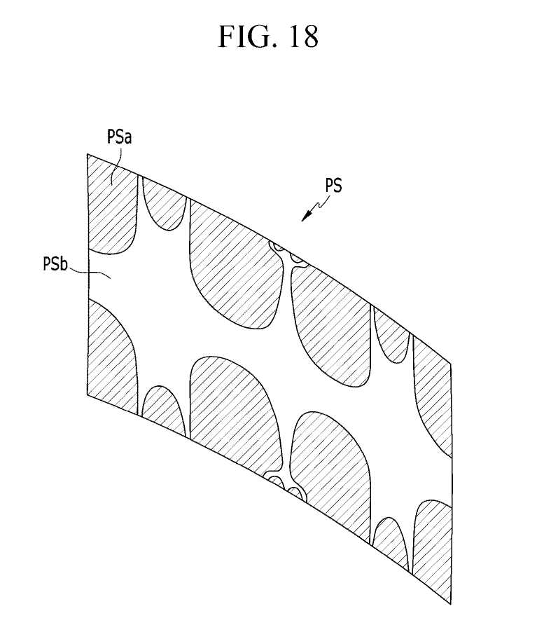

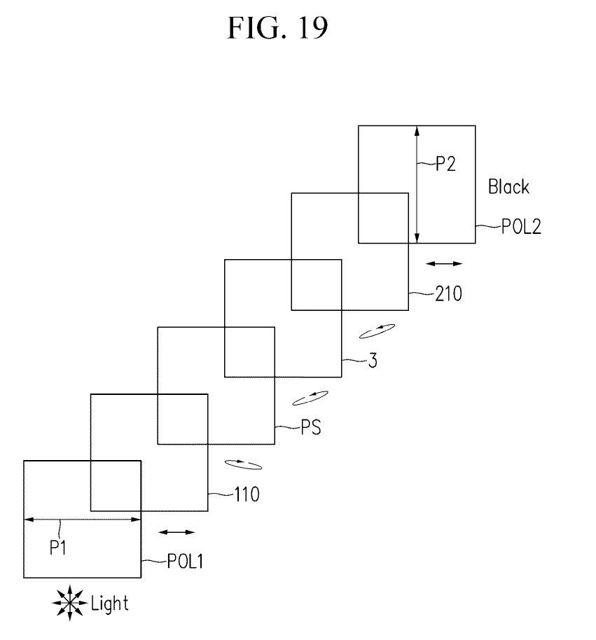

An exemplary embodiment in which a phase compensation layer is used to remove the black mura without correcting the image data signal DAT will now be described with reference to FIGS. 17 to 21. FIG. 17 is a cross-sectional view of one pixel of a curved LCD according to a further exemplary embodiment of the present invention. FIG. 18 is a perspective view of a phase compensation layer PS included in the curved LCD of FIG. 17. FIG. 19 is a top plan view illustrating how light is polarized in the curved LCD of FIG. 17.

Unlike as shown in FIG. 4, the phase compensation layer PS is disposed on the first insulation substrate 110. The phase compensation layer PS includes a first phase region PSa for changing a phase to correspond to black mura regions, and a second phase region PSb for maintaining a phase in the normal regions.

The first and second phase regions PSa and PSb have different phase delay values from each other.

A liquid crystal material in a monomer state may be coated and then cured (polymerized), thereby producing a film type phase compensation layer PS in a polymer state. The first phase region PSa is formed to compensate elliptically polarized light created by the first and second insulation substrates 110 and 210. As shown in FIG. 19, when the first and second insulation substrates 110 and 210 change polarized light to right elliptically polarized light rotating in a clockwise direction, the phase compensation layer PS may be formed to change this polarized light to left elliptically polarized light rotating in a counterclockwise direction.

After being transmitted through the first polarizer POL1, birefringence in the first insulation substrate 110 converts light linearly polarized in a direction of a first polarization axis P1 into right elliptically polarized light rotating in the clockwise direction. This right elliptically polarized light becomes left elliptically polarized light when transmitted through the phase compensation layer PS.

Since an electric field is not generated in the liquid crystal layer 3, the left elliptically polarized light is transmitted therethrough with its polarization unchanged. The left elliptically polarized light then passes through the second insulation substrate 210 such that its linearly polarized light component in the direction of the second polarization axis P2 is compensated while its linearly polarized light component in the direction of the first polarization axis P1 remains.

The linearly polarized light in the direction of the first polarization axis P1 is not allowed to transmit through the second polarizer POL2. Accordingly, the black mura due to the shear stress acting on the first and second insulation substrates 110 and 210 may be removed.

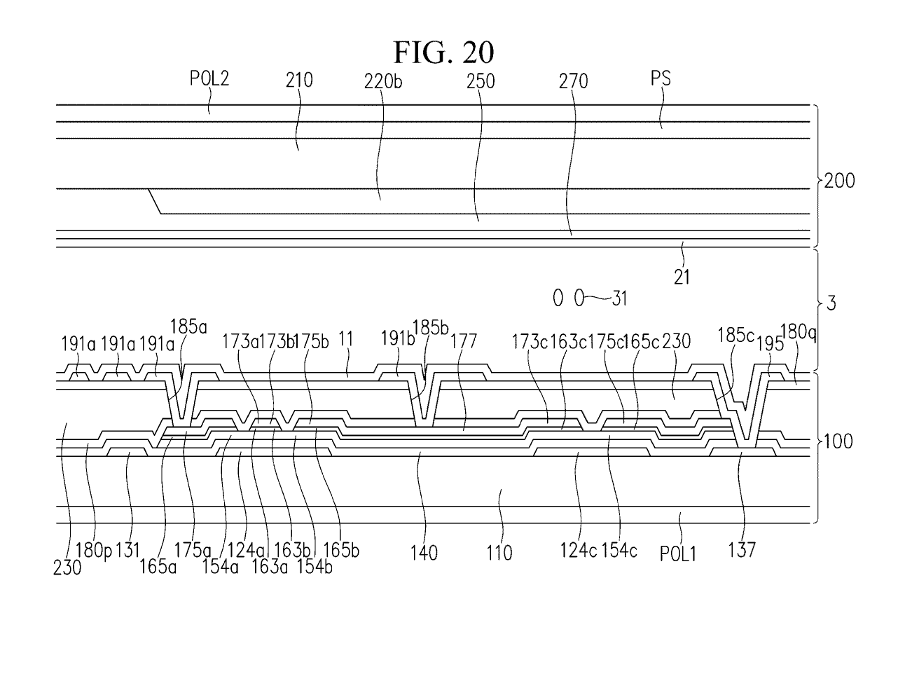

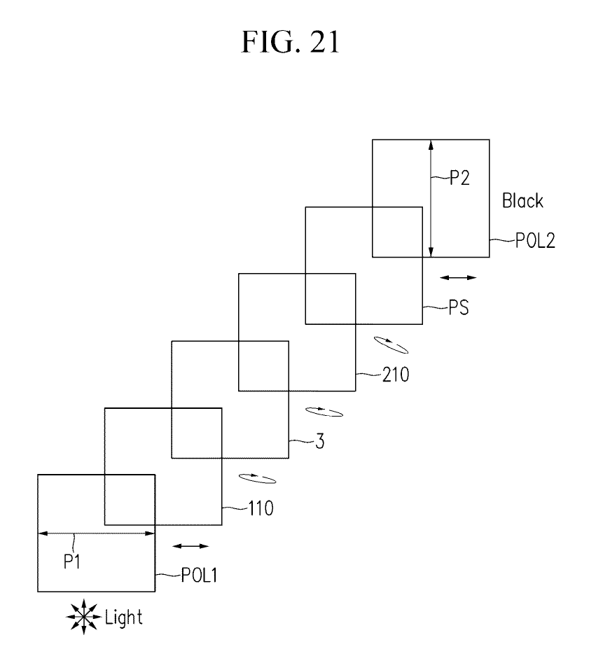

FIG. 20 is a cross-sectional view of one pixel of a curved LCD according to a further exemplary embodiment of the present invention. FIG. 21 is a top plan view illustrating polarization variation in the curved LCD of FIG. 20.

Unlike the configuration shown in FIG. 17, a phase compensation layer PS is not formed on a first insulation substrate 110 but is disposed between a second insulation substrate 210 and a second polarizer POL2.

As shown in FIG. 18, the phase compensation layer PS includes a first phase region PSa for changing the phase of light in the black mura region, and a second phase region PSb for maintaining the phase of light in the normal region.

As shown in FIG. 21, when the first and second insulation substrates 110 and 210 change polarized light to right elliptically polarized light rotating in a clockwise direction, the phase compensation layer PS may be formed to change this light to left elliptically polarized light rotating in a counterclockwise direction.

After being transmitted through the first polarizer POL1, light linearly polarized in a direction of a first polarization axis P1 becomes right elliptically polarized light rotating in the clockwise direction when it passes through the first insulation substrate 110.

Since an electric field is not generated in the liquid crystal layer 3, right elliptically polarized light is transmitted therethrough with its polarization unchanged. This right elliptically polarized light is further rotated in the clockwise direction while being transmitted through the second insulation substrate 210, and becomes right elliptically polarized light with the linearly polarized light component further increased in the direction of the second polarization axis P2.

The right elliptically polarized light is then transmitted through the phase compensation layer PS such that its linearly polarized light component in the direction of the second polarization axis P2 is compensated while its linearly polarized light component in the direction of the first polarization axis P1 remains.

The linearly polarized light in the direction of the first polarization axis P1 is not allowed to transmit through the second polarizer POL2. Accordingly, the black mura due to shear stress acting on the first and second insulation substrates 110 and 210 may be removed.

The phase compensation layer PS may be integrally formed with the second polarizer. That is, the second polarizer POL2 may include a phase delay layer having regions with different phase delay values. In this case, as shown in FIG. 21, the second polarizer POL2 may be formed to include first and second phase regions PSa and PSb.

The accompanying drawings and the detailed description of the invention are only illustrative, and are used for the purpose of describing the present invention but are not used to limit the meanings or scope of the present invention described in the claims. Therefore, those skilled in the art will understand that various modifications and other equivalent embodiments of the present invention are possible. Thus, the various features of the embodiments disclosed herein or otherwise may be mixed and matched in any combination, so as to create further embodiments consistent with the invention. Additionally, the true technical protective scope of the present invention must be determined based on the technical spirit of the appended claims.

### DESCRIPTION OF SYMBOLS

1100: signal controller
1200: gate driver
1300: data driver
1400: gray-level voltage generator
1500: liquid crystal panel assembly
1600: look-up table
1700: detection panel
1800: black mura detection unit

What is claimed is:

1. A curved liquid crystal display (LCD) comprising:
a curved liquid crystal panel assembly;
a look-up table storing correction values, the correction values being values for selectively correcting image signals for a black mura region of the curved liquid crystal panel assembly; and
a signal controller for generating an image data signal adjusted by the correction values of the image signals for the black mura region.

2. The curved LCD of claim 1, wherein when a black image is displayed, the signal controller is further programmed to generate the image data signal so as to generate a predetermined electric field in portions of the curved liquid crystal panel assembly corresponding to the black mura region, and to generate no electric field in normal regions corresponding to portions of the curved liquid crystal panel assembly outside the black mura region.

3. The curved LCD of claim 2, wherein, when the black image is displayed, a voltage of the image data signal applied to the black mura region is different from a voltage of the image data signal applied to the normal regions.

4. The curved LCD of claim 1, wherein, when a white image is displayed on the curved liquid crystal panel assembly, a voltage of the image data signal applied to the black mura region is different from a voltage of the image data signal applied to the normal regions.

5. The curved LCD of claim 1, wherein, when a white image is displayed on the curved liquid crystal panel assembly, a voltage of the image data signal applied to the black mura region is substantially equal to a voltage of the image data signal applied to the normal regions.

6. The curved LCD of claim 1, wherein, when an arbitrary gray level image is displayed on the curved liquid crystal panel assembly, a voltage of the image data signal applied to the black mura region is different from a voltage of the image data signal applied to the normal regions.

7. A method of driving a curved LCD including a curved liquid crystal panel assembly, the method comprising:
receiving an image signal for displaying an image;
retrieving correction values, the correction values being correction values for image signals for an image to be displayed in a black mura region of a curved liquid crystal panel assembly;
generating an image data signal by correcting the image signals based on the retrieved correction values; and
displaying the image on the liquid crystal panel assembly according to the image data signal.

8. The driving method of claim 7, wherein the generating an image data signal further comprises, while a black image is displayed on the curved liquid crystal panel assembly, generating a predetermined electric field in portions of the curved liquid crystal panel assembly corresponding to the black mura region, and generating no electric field in normal regions corresponding to portions of the curved liquid crystal panel assembly outside the black mura region.

9. The driving method of claim 8, wherein the generating an image data signal further comprises, while a black image is displayed on the curved liquid crystal panel assembly, applying a first data signal voltage to the black mura region of the curved liquid crystal panel assembly and applying a second data signal voltage to the normal region of the curved liquid crystal panel assembly, the first and second data signal voltages being different from each other.

10. A curved LCD comprising:
a curved liquid crystal panel assembly;
a detection panel disposed on the curved liquid crystal panel assembly to detect light passing through the liquid crystal panel assembly;
a black mura detection unit for detecting a black mura region corresponding to black mura generated in the curved liquid crystal panel assembly; and
a signal controller for generating an image data signal selectively adjusted according to location information of the black mura region.

11. The curved LCD of claim 10, wherein, when a black image is displayed, the signal controller is further programmed to generate the image data signal so as to generate a predetermined electric field in portions of the curved liquid crystal panel assembly corresponding to the black mura region, and to generate no electric field in normal regions corresponding to portions of the curved liquid crystal panel assembly outside the black mura region.

12. The curved LCD of claim 10, wherein the detection panel includes: a plurality of detection gate lines; a plurality of detection lines; and a plurality of detection pixels connected to the plurality of detection gate lines and the plurality of detection lines to measure an amount of light passing through the curved liquid crystal panel assembly.

13. The curved LCD of claim 12, wherein the black mura detection unit is connected to the plurality of detection gate lines and the plurality of detection lines, is programmed to sequentially apply a gate-on voltage to the plurality of detection gate lines, and is further programmed to receive light detection signals that are generated in the plurality of detection pixels and transmitted through the plurality of detection lines in response to the gate-on voltage.

14. The curved LCD of claim 13, wherein the black mura detection unit is programmed to detect a region in which the light detection signals exceed a predetermined reference value, so as to detect the black mura region.

15. The curved LCD of claim 14, wherein the reference value is a voltage corresponding to an amount of current that can be generated in one detection pixel by external light.

16. The curved LCD of claim 15, wherein the black mura detection unit is further programmed to calculate the reference value according to an average value of the light detection signals of the plurality of detection pixels.

17. A method of driving a curved LCD, the method comprising:
sequentially transmitting a gate-on voltage to a plurality of detection gate lines while a black image is displayed;
receiving light detection signals generated by a plurality of detection pixels connected to the plurality of detection gate lines;
determining whether the light detection signals exceed a reference value;
determining a black mura region according to positions of those detection pixels having voltages of the light detection signals that exceed the reference value;
generating black mura region information indicating a position of the black mura region; and
correcting an image data signal corresponding to the black mura region based on the black mura region information.

18. The method of claim 17 wherein, when a black image is displayed on a curved liquid crystal panel assembly, a voltage of the data signal applied to display pixels corresponding to the black mura region and a voltage of the data signal applied to display pixels corresponding to locations outside the black mura region are different from each other.

19. A curved LCD, comprising:
a lower panel including a first polarizer and a first insulation substrate;
an upper panel including a second polarizer and a second insulation substrate;
a liquid crystal layer interposed between the lower and upper panels; and
a phase compensation layer disposed on one of the lower panel and the upper panel, wherein
the phase compensation layer has different phase delay values for a black mura region of the curved upper and lower panels and a normal region outside the black mura region.

20. The curved LCD of claim 19, wherein the phase compensation layer is disposed between the first polarizer and the second polarizer.
